(19) United States
(12) Patent Application Publication
(10) Pub. No.: US 2002/0184049 A1
(43) Pub. Date: Dec. 5, 2002

(54) Method and apparatus for the extension of a user session based on the expected value of the activities presented in the extend session

(75) Inventor: James T. Brady, San Jose, CA (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: FORECOURT COMMUNICATION GROUP

(21) Appl. No.: 10/155,637

(22) Filed: May 23, 2002

Related U.S. Application Data
(60) Provisional application No. 60/293,689, filed on May 25, 2001.

(51) Int. Cl. G06F 17/60

(52) U.S. Cl. 705/1

(57) ABSTRACT

A system for scheduling activities at a user terminal associated with a point-of-service station, such that the users idle time is exceeded when the value of the idle time is likely to exceed the cost of overrunning the primary transaction associated with the point-of-service station. When the cost of overrun is expected to be greater than the value of the activity the activity is not presented to the user. This determination is made by using value criteria, the expected value of the activity, and the expected overrun of the activity. Additionally, the value criteria may be modified by the interarrival time of users at the point-of-service station or the utilization of the point-of-service station.

### FIELD OF THE INVENTION

This invention relates to extending a session that is presenting activities to a user based on the potential value of the additional time consumed in relationship to the value of the primary use of the facility occupied by the user. Said facility are: gas dispensers in a gas stations; check out counters in grocery stores, pharmacies, and other retail stores; ATMs; and other point-of-service terminals.

### BACKGROUND OF THE INVENTION

Recent additions to the capability of point-of-service terminals have enabled them to present visual and audio materials to the user and permit the user to interact with the systems supporting said point-of-service terminal. This has opened up the opportunity to present activities to the users that are not directly related to the primary purpose of the point-of-service terminal. Activities are interactive dialogs with the user, having an object of transferring value to the user. Some of the activities include advertisements, information presentations, offers to sell products or services, information queries . . . This allows the system to offer a broad range of activities, including: sale of products and services, communication of information, entertainment, issuance of coupons and other certificates.

These presentations occur during the final minutes of a purchase of products in a retail environment, when the user is idle for a time (idle time). In a multilane store, (grocery, variety goods, etc.) the user waits for the checkout clerk to ring up the purchases. In a gas station, the user waits for the attendant or pump to fill the tank. This is wasted time. The wasted time is called “idle time”. In general, neither the user nor the store benefits from the activities of the user during this time. Systems have been built to present activities as describe above, to users during the wasted time. Such as system is described in docket 09/497,744.

The systems available today, do not attempt to terminate presentation of activities, or terminate them as soon as possible after the primary transaction has completed. Both have an economic impact on the retailer. If a primary transaction completes and the store is very busy, the retailer experiences “balking” if the presentation of activities continues after the primary transaction completes. That is, users will abandon their attempts to purchase goods and go to another store where the lines are not as long. During these times of heavy load, the retailer would like to minimize the activities overrunning the completion of the primary transaction. Conversely, if there are few users in the store, then the presentation of additional activities has little cost with respect to the economic benefit of continuing the presentation of activities, making overrun acceptable. There is a value trade-off in addition to the overrun trade-off. In this case, the value of the additional activities may exceed the cost of providing the resources necessary to tolerate overrun. These resources may be the hireling of additional checkers to staff otherwise vacant checkout counters.

### SUMMARY OF THE INVENTION

It is an object of this invention to determine when the activity presenting system should continue the presentation of activities after the primary transaction involving the presenting facility has completed.

It is another object of this invention to provide the owner of a venue, having point-of-service terminals that can interact with the users, with a mechanism to specify criterion concerning the overrun tolerated based on the potential value of the activities that can be presented after the primary transaction completes.

It is another object of this invention to allow the selection of activities during the primary session base on their value, even if they will probably cause overrun.

It is another object of this invention to provide criteria to allow trade-offs to be made by the system based on the utilization of the point-of-service terminal, and the value of activities.

The invention is system in the form of programming instructions and computing equipment embodied in a venue server that provides activities to point-of-service terminals. This system provides the venue (store) owner with the ability to specify criteria concerning the value and overrun trade-offs. The system measures the activity prior to the point of exercising these trade-offs to provide information about the utilization of the system. The system allows the input of value parameters for activities from the provider of the activities and input of the marginal cost associated with running the point-of-service terminal.

When the system is running, a control mechanism contained in the invention, calculates the expected economic value of running a specific activity. That calculation includes the potential costs and revenue that would accrue from the activity. If the expected economic value does not meet the value criterion, the activity is not run, otherwise, if it meets the overrun criterion, it would be selected for presentation to the user. When the activity completes the process iterates until no activity meet the criteria.

In some embodiments, multiple activities would be considered by the control mechanism, and the one with the highest economic value would be chosen for presentation.

The foregoing and still further objects and advantages of the present invention will be more apparent from the following detailed explanation of the preferred embodiments of the invention in connection with the accompanying drawing.

### BRIEF DESCRIPTION OF THE DRAWINGS

FIG. 1 is a diagram of a computer System, which is adapted to perform the method of the invention.

FIG. 2 is a diagram of a computer system called the Central Server.

FIG. 3 is a diagram of a User Interface.

FIG. 4 is a diagram of a computer system called the Venue Server.

FIG. 5 is a data table that describes a User Identification Table.

FIG. 6 is a data table that describes an Idle Time Message.

FIG. 7 is the Activity Description Table.

FIG. 8 is a data table that describes a Venue Table.

FIG. 9 is a data table that describes a User Information Table.

FIG. 10 is the Proposed Activity Table.

FIG. 11 is the flow chart of the Activity Scheduler.

FIG. 12 is the flow chart of the Activity Pre-selection process.

FIG. 13 is the flow chart of the Utilization Update process.

### DETAILED DESCRIPTION OF THE INVENTION

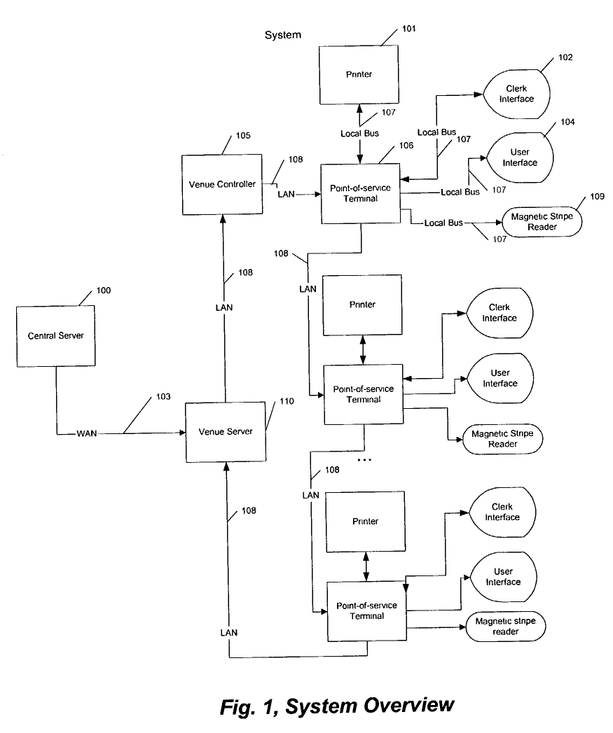

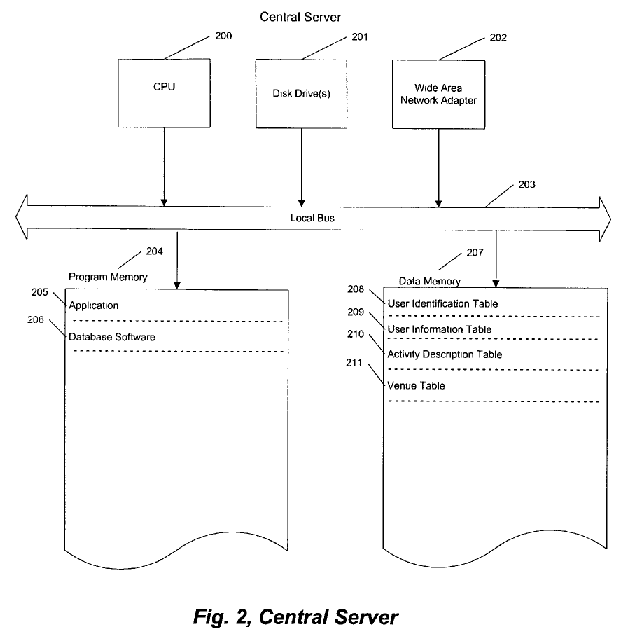

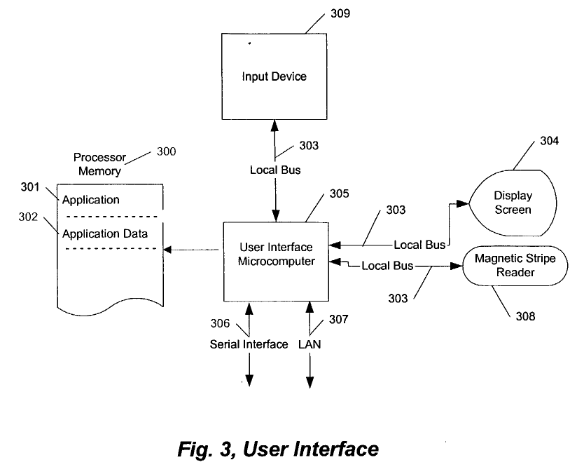

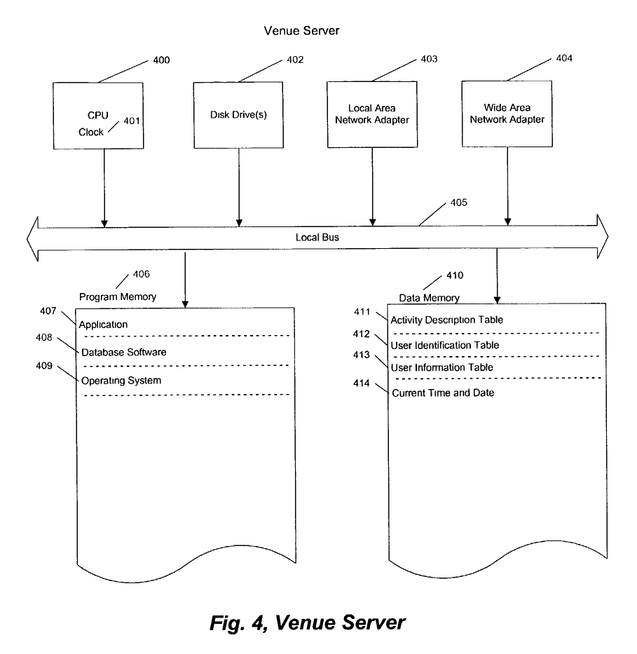

FIG. 1 is a diagram of a network of computers adapted to perform the method of the invention. A Central Server 100, described in FIG. 2, is coupled by a wide area network, WAN 103 to one or more Venue Servers 110. Readily available software and protocols such as TCP/IP are used by Central Server 100 and Venue Server 110, described in FIG. 4, to communicate with each other via WAN 103. Venue Controller 105 and Venue Server 110 are connected via LAN 108 to one or more Point-of-service Terminals 106. Nothing is taught herein that prohibits embodiments which combine Central Server 100, Venue Controller 105 and Venue Server 110 in various combinations. Normal Point-of-service Terminal activities are conducted between the Venue Controller 105 and Point-of-service Terminal 106. Connect to the Point-of-service Terminal 106 via a Local Bus 107 are the User Interface 104, Clerk Interface 102, Magnetic Stripe Reader 109 and a Printer 101. User Interface 104, described in FIG. 3, has a Display Screen 304 and Input Device 309 for communicating with the User. Magnetic Stripe Reader 109 is provided to allow the input of user identification information from a variety of identification cards and is often the source of the first user response. These are described in FIG. 3. The Clerk Interface 102 is normally involved with checkout processing. Output device, Printer 101, is for hardcopy printouts such as receipts, advertisements, coupons, and other information.

FIG. 2 Illustrates further details of Central Server 100 as seen in FIG. 1, System. Central Server performs the functions of collecting user data and venue data, analyzing the data to extract information concerning buying habits and thinking characteristics of the user, and information about the performance characteristics of the venue. CPU 200 is a conventional microprocessor with a Local Bus 203 that connects it to Disk Drive(s) 201, a Wide Area Network Adapter 202, a Program Memory 204, and a Data Memory 207. Program Memory 204 contains Application 205 that CPU 200 uses to perform the following functions. It collects information stored in Venue Server 110 via WAN 103 using standard communication protocols such as TCP/IP. The information collected is in the form of the following tables: User Identification Table 208, Venue Table 211, and Activity Description Table 210. This information is stored using Database Software 206 into Data Memory 207 and subsequently onto Disk Drive(s) 201.

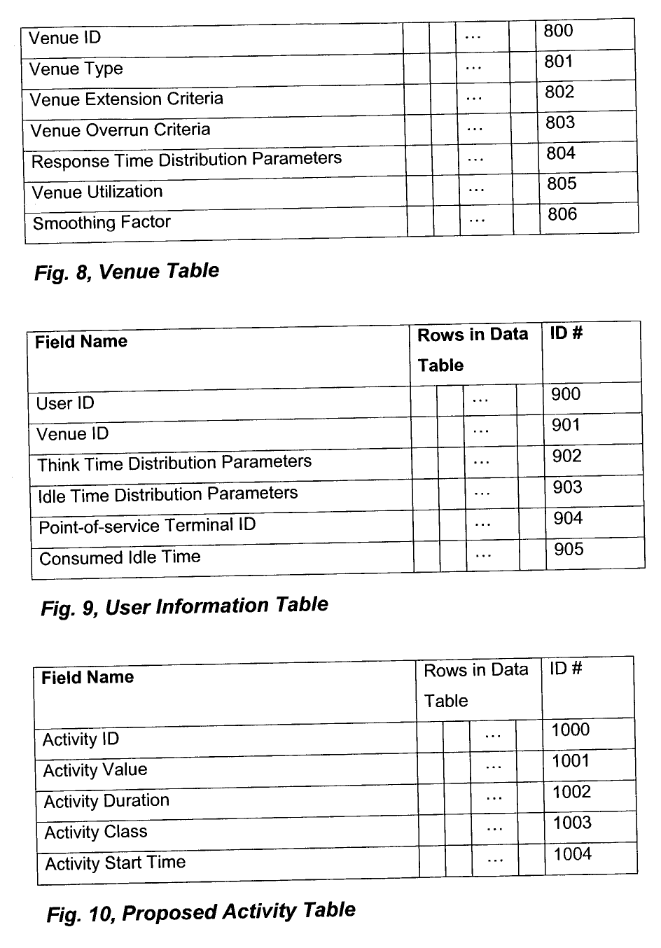

Periodically a program in Application 205 analyzes data collected from all Venue Servers 110 to produce the FIG. 9, User Information Table 209, FIG. 6 User Identification Table 208, FIG. 7, Activity Description Table 210, and FIG. 8, Venue Table 211. User Information Table 209 and FIG. 8, Venue Table are sent, via the Local Bus 203 and Wide Area Network Adapter 202 to the Venue Server 110 specified in the Venue ID 901, and Venue ID 800 of the respective tables, or to all venues if the table does not contain a Venue ID.

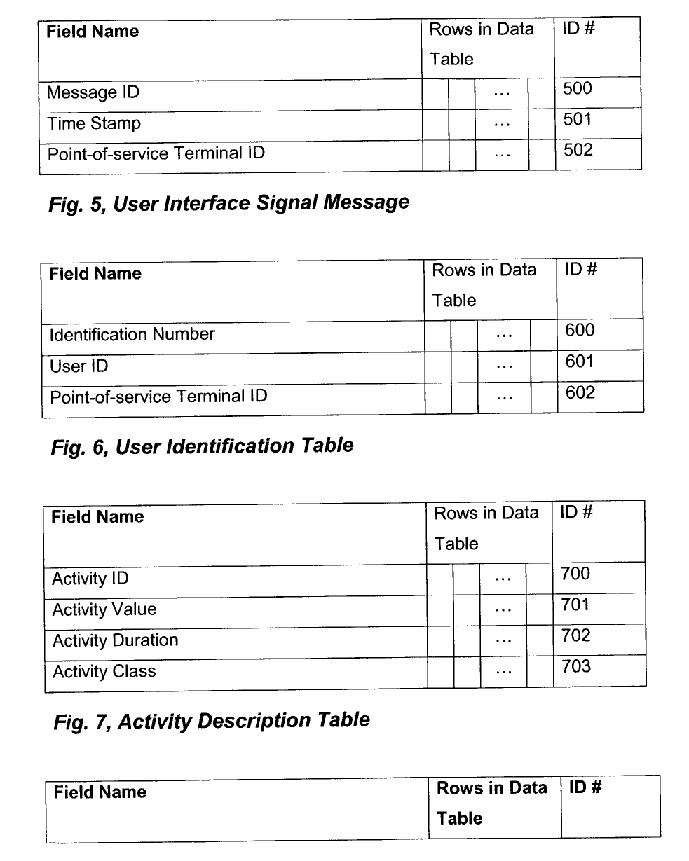

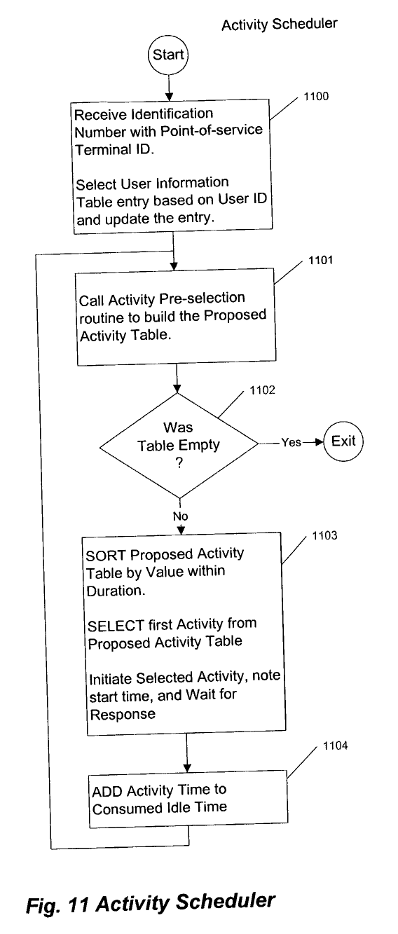

FIG. 3 is a diagram of User Interface as seen in FIG. 1, User Interface 104 has a User Interface Microcomputer 305 that is attached via a LAN 307 or Serial Interface 306 to Venue Controller 105 and Venue Server 110 (optionally), and is attached to Venue Server 110 via LAN 307. User Interface has a Display Screen 304, which can display textual and (optionally) graphical information to the user. Magnetic Stripe Reader 308 is provided to allow the input of user identification information from a variety of identification cards. Input Device 309 (like a keypad or touch screen) is used to allow the user to manually input information. Input Device 309 is typically a keypad or a touch screen. As User Interface Microcomputer 305 is programmable, it is capable of performing the various functions described elsewhere. The elements of FIG. 3, User Interface, are connected by a Local Bus 303. As implementations vary from manufacturer to manufacturer, more than one Local Bus 303 may be used. Processor Memory 300 contains Application 301 and Application Data 302 need to run the User Interface. Application 301 generates FIG. 5 User Interface Signal Message, when a User Response or Screen Display is processed, and sends it to Application 407 in Venue Server 110 for processing, as described in FIG. 11, Utilization Update.

FIG. 4 Venue Server is a representation of a Venue Server 110, from FIG. 1. Venue Server is described as though it is implemented as a separate computer system, however the function provided can be performed in Venue Controller 105, or other computer systems through the use of local and wide area networks. FIG. 4, Venue Server, communicates with Central Server 100 via Wide Area Network Adapter 404 to acquire the information and store it in Data Memory 410 and on Disk Drive(s) 402. Internally the various components communicate via Local Bus 405. The tables acquired are User Information Table 413 (described in FIG. 9, User Information Table), and User Identification Table 412. Application 407, in Program Memory 406, makes use of commercially available Database Software 408 to the provide storage, selection and retrieval functions and Operating System 409 to provide the task initiation and control and timer services that it needs. The process described in FIG. 11 is a part of Application 407.

Data Memory 410 also contains Activity Description Table 411 that is described in FIG. 7; User Identification Table 412 that is described in FIG. 6; User Information Table 413 that is described in FIG. 9; and Current Time and Date 414 provided from Clock 401 in CPU 400. The Current Time and Date 414 is used to update Consumed Idle Time 905 as each activity is completed.

Venue Server also communicates via Local Area Network Adapter 403 to LAN 108 in FIG. 1 to Venue Controller 105 and various Point-of-service Terminals 106.

FIG. 5 is the User Interface Signal Message. These signals are messages generated by User Interface 104, from FIG. 3, User Interface, when it detects the display of a new screen or a user response. Message ID 500 specifies whether the signal is a ‘User Response’ or a ‘Screen Display’. Point-of-service Terminal ID 502 associates that signal with a specific user terminal station. Then Point-of-service Terminal ID 502 is then associated to a specific user via the field, Point-of-service Terminal ID 904, from FIG. 9, User Information Table. Time Stamp 501 gives the time of the event triggering the message. Time Stamp 501 is used in the calculation of response time, which is used in FIG. 11 Activity Scheduler.

FIG. 6 is the User Identification Table. The table associates Identification Number 600 with User ID 601, which is assigned by Central Server 100 when the user is initially added to the system. Some sources of identification numbers are Credit, Debit, and Loyalty cards. When an Identification Number 600 is supplied from Magnetic Stripe Reader 308 or Input Device 309 it is used to find the entry in this table with the matching Identification Number 600. The associated User ID 601 is used to find the user's entry in FIG. 9 User Information Table, with User ID 900 equal to User ID 601. Point-of-service Terminal ID 602 associates that signal with a specific user terminal station and is set when the Identification Number 600 is read by Magnetic Stripe Reader 308 or keyed into Input Device 309. This table allows a user to have multiple entries, each having a unique Identification Number 600.

FIG. 7 is the Activity Description Table, that has all the activities offered in the venue. An Activity is a single screen or a group of screens that create dialogs by stringing together screens based on user response. The activity is uniquely identified by the Activity ID 700. Activity Value 701 is the value to the business entities that are involved in the offering associated with the activity and is used to build FIG. 10, Proposed Activity Table, Activity Value 1001. Activity Duration 702 specifies the parameters of a probability distribution for the length of time the activity will take in a system with no load. Activity Class 703 indicates whether the activity is “terminate-able” or “must complete”. FIG. 7, Activity Description Table, is built by Central Server 100 as activities are entered into the system.

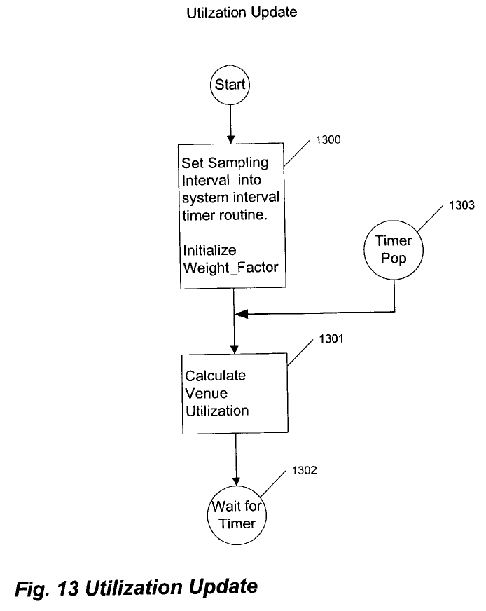

FIG. 8 is the Venue Table. The table contains a Venue ID 800 that uniquely identifies the venue; Venue Type 801 that is used, optionally, to build a FIG. 9, User Information Table, that span instances of the same Venue Type 801; Venue Extension Criteria 802 which is used to determine if the Venue Overrun Criteria 803 should be used, Venue Overrun Criteria 803 which is used to determine if an entry in the FIG. 10, Proposed Activity Table, can be selected for presentation. It is stated in terms of the acceptable probability of overrun. Response Time Distribution Parameters 804 are calculated dynamically from the utilization of CPU 400, the duration between a Screen Display and User Response pair of FIG. 5 User Interface Signal Messages. Venue Utilization 805 is the current utilization. Smoothing Factor 806 is used to dampen the variations in Venue Utilization, as described in FIG. 13. FIG. 8, Venue Table, is built by Central Server 100 as stores are entered into the system, and then selectively transferred via WAN 103 to the Venue Server 110 specified by the Venue ID 800.

FIG. 9 is a data table describing the User Information Table. This contains the information about the user's time consumption habits in various circumstances. User ID 900 identifies a unique user. A number of values for User ID 900 are set aside, to specify information for anonymous users. When a User ID 900 is not supplied by the Point-of-service Terminal 106 at the start of a transaction, a User ID 900 is constructed and new entry is constructed in FIG. 9 User Information Table for that user. The Point-of-service Terminal ID for the Point-of-service Terminal 106 used, will be placed into Point-of-service Terminal ID 904. Venue ID 901 identifies the venue for FIG. 9 User Information Table. This allows the support of multiple venues. Think Time Distribution Parameters 902, specify the probability distribution developed from think time samples at the time FIG. 9, User Information Table was last updated. The probability distributions used herein, can take many forms, including gamma or normal. They can be specified by a plurality of parameters. Think Time Distribution Parameters 902 are used in conjunction with Activity Duration 1002 to produce an activity duration probability distribution that is used in FIG. 11, Activity Scheduler, to calculate the expected overrun of an activity.

In a similar manner, Idle Time Distribution Parameters 903 specify the probability distribution for the users idle time. Point-of-service Terminal ID 904 is assigned to the user at the start of the user session at the terminal. Consumed Idle Time 905, are calculated for each activity as part of the computations done in FIG. 11, Activity Scheduler. FIG. 9, User Information Table, is generated and stored at Central Server 100, and then selectively transferred via WAN 103 to the Venue Server 110 specified by the Venue ID 901.

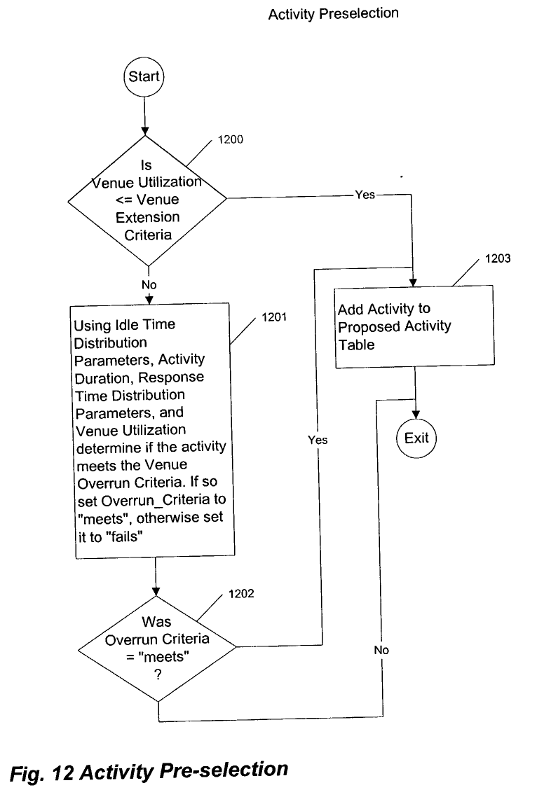

FIG. 10 is the Proposed Activity Table, that has all the activities offered in the venue. It is constructed by copying the fields Activity ID 700 to Activity ID 1000, Activity Value 701 to Activity Value 1001, Activity Duration 702 is used in FIG. 12, Activity Pre-selection, to calculate Activity Duration 1002, and Activity Class 703 to Activity Class 1003, from selected entries in the FIG. 7, Activity Description Table. Activity Start Time 1004 is used in the recalculation of Consumed Idle Time 905 at the completion of each activity.

FIG. 11 is the flow chart of the Activity Scheduler, comprised of the following steps: Step 1100 detects the user by receiving an Identification Number 600 and Point-of-service Terminal ID 602 from the Point-of-service Terminal 106. If Identification Number 600 is null, an anonymous User ID 601 is assigned. Then the FIG. 6 User Identification Table is updated for that User ID 601 and Point-of-service Terminal ID 602, with the Identification Number 600 set to null. If Identification Number 600 is not null it is used to locate User ID 601 in FIG. 6, User Identification Table and subsequently locate the entry in FIG. 9, User Information Table, for that user. Then Step 1101 calls FIG. 12, Activity Pre-selection, which returns FIG. 10, Proposed Activity Table, which is checked in Step 1102 to determine if it is empty, indicating that the process cannot be continued. If it is empty, the routine exits, terminating the presentation of activities. Otherwise, control passes to Step 1103, which sorts the FIG. 10, Proposed Activity Table into descending Activity Value 1001, within descending Activity Duration 1002 sequence. The first entry in FIG. 10, Proposed Activity Table is presented to the user. When the activity completes control is passed to Step 1104, which decrements Consumed Idle Time 905 by the amount of time the activity consumed. Control then passes to Step 1101.

FIG. 12 is a representation of the Activity Pre-selection process. Step 1200 compares Venue Utilization 805 to the Venue Extension Criteria 802. If the result is “less than or equal” the venue allows an activity from FIG. 7 Activity Description Table to be selected as candidate for presentation to the user, and control passes to Step 1202. Otherwise, each activity must be checked as in Step 1201. Step 1201 calculates the probability that the activity specified by Activity ID 700 will complete in the idle time as specified by Idle Time Distribution Parameters 903 (ITDP) and Consumed Idle Time 905. The first phase is the computation of an Activity Duration Distribution (ADD) from Activity Duration 702 (AD), Response Time Distribution Parameters 804, (RTDP) and Venue Utilization 805 (u). The response time distribution in this embodiment is the normal distribution having a mean (m) and a standard deviation (sd) and the Activity Duration Distribution will be likewise distributed with mean (M) and standard deviation (SD). The calculation of ADD parameters is as follows:

M=AD*m*(1/(1−u))

SD=AD*sd*(1/(1−u))

M=AD·m·(1/(1−u))

SD=AD·sd·(1/(1−u))

The distribution is represented by the function n(x, m, sd).

The Activity Duration 1002 is set to M.

The next computation finds the probability (p) that the activity, having the above parameters, will complete in the idle time specified by Idle Time Distribution Parameters

$$p = {\int }_{x = m - k \cdot sd}^{m + k \cdot sd} {\int }_{y = 0}^{m + k \cdot sd} n \cdot ( x , m , s ⅆ ) - g ( y , α , β )$$

903 and Consumed Idle Time 905 (represented by c). In this embodiment, a gamma distribution is used, having parameters a and b. The distribution is represented by the function g(y, a, b, c). The value k is picked to give a low error in estimating the probability. Given this the probability is estimated by:

$$p = {\int }_{x = m - {k}^{*} sd}^{m + {k}^{*} sd} {\int }_{y = 0}^{∞} n ( x , m , s ⅆ ) - g ( y , a , b , c )$$

If p is less than Venue Overrun Criteria 803, Step 1202 control will pass to Step 1203, otherwise the routine will exit returning to the calling routine. Step 1203 copies: Activity ID 700 to Activity ID 1000, Activity Value 701 to Activity Value 1001, and Activity Class 703 to Activity Class 1003 in FIG. 10, Proposed Activity Table, and exit, returning to the calling routine.

FIG. 13 is a representation of the Utilization Update routine flowchart. The routine starts at system bring-up and remains in service while the Venue Server 110 is in operation. Step 1300 is executed when the routine is started during the initialization of the Venue Server 110. It uses timer services provided by the Operating System 409 to set up the interval timer to provide a periodic timer signal (Timer Pop 1303), and initializes a Weight Factor for smoothing the Venue Utilization 805. It then passes control to Step 1301, which accesses the Operating System 409 services to determine the current processor utilization (PU). The PU is multiplied by the Smoothing Factor 806 and added to the product of Venue Utilization 805 and (1—Smoothing Factor 806), and is stored into Venue Utilization 805, completing the computation. It then passes control to Wait for Timer 1302.

The Operating System 409 timer services will activate Timer Pop 1303 each interval, passing control to Step 1301.

The invention having been thus described with particular reference to the preferred forms thereof, it will be obvious that various changes and modifications may be made therein without departing from the spirit and scope of the invention as defined in the appended claims.

What is claimed:

1. A system for determining if additional activities can presented to a user during idle time of a primary transaction of a user at a terminal in a venue, in a manner that optimized the value to said venue, the system comprising:
at least one terminal located at the venue of said primary transaction, including means for presenting activities to said user and for receiving responses from said user;
a venue server with which said terminal can communicate, said venue server having an activity database describing said activities available for presentation to said user, and a venue database;
said activity database having means to identify and define said activities for presentation to said user, the value of said activities, and a means to establish the time to completion of said activity;
said venue database having means to specify the value of said primary transactions of said venue, and means to specify a value criteria for determining if said activity should be presented;
means to associate said user with one or more said activities;
means for estimating an expected user idle time;
means for selecting one of said associated activities such that said activities has an estimated time that probably does not exceed said
expected user idle time, unless said value of said activity meets said value criteria.

2. A system as in claim 1, having further means to selecting an additional said activity after the completion of said activity.

3. A system as in claim 1, having further means to determine the utilization of a point-of-service station associated with said terminal, and to use said utilization to modify said selection means.

4. A system as in claim 1, having further means to determine the interarrival time of user to a point-of-service station associated with said terminal, and to use said interarrival time to modify said selection means.

5. A system as in claim 1, having further means to specify said value of said primary transaction and said value of said activities in terms of a time-value.

6. A system as in claim 5, having further means to calculate the expected value of said activities based on the duration of the expected overrun of said activities, using said calculated expected value in said means for selecting activities.

7. A system for determining if additional activities can presented to a user during idle time of a primary transaction of a user at a terminal in a venue, in a manner that optimized the value to said venue, the system comprising:
at least one terminal located at the venue of said primary transaction, including means for presenting activities to said user and for receiving responses from said user;
a venue server with which said terminal can communicate, said venue server having an activity database describing said activities available for presentation to said user, and a venue database;
said activity database having means to identify and define said activities for presentation to said user, the value of said activities, and a means to establish the time to completion of said activity;
said venue database having means to specify the time-value of said primary transactions of said venue, and value criteria for continuation of said activity said presentation to said user;
means to associate said user with one or more said activities;
means for detecting the end of idle time;
means for selecting from one or more of said associated activities such that said selected activity has an estimated value that meets said value criteria.

8. A system as in claim 7, having further means to selecting an additional said activity after the completion of said activity.

9. A system as in claim 7, having further means to determine the utilization of a point-of-service station associated with said terminal, and to use said utilization to modify said value criteria.

10. A system as in claim 7, having further means to determine the interarrival time of user to a point-of-service station associated with said terminal, and to use said interarrival time to modify said value criteria.

11. A system as in claim 7, having further means to specify said value of said primary transaction and said value of said activities in terms of a time-value.

12. A system as in claim 11, having further means to calculate the expected value of said activities based on the duration of the expected overrun of said activities, using said calculated expected value in said means for selecting activities.
